(19) United States
(12) Patent Application Publication
(10) Pub. No.: US 2008/0157901 A1
(43) Pub. Date: Jul. 3, 2008

(54) Device for the propagation of electromagnetic waves with modulated dielectric constant

(76) Inventors: Ladislau Matekovits, Torino (IT); Paola Pirinoli, Torino (IT); Guillermo Carlos Vietti Colome, Torino (IT); Mario Orefice, Torino (IT)

Correspondence Address: PAUL A. FATTIBENE;FATTIBENE & FATTIBENE, 2480 POST ROAD, SOUTHPORT, CT, 06890, US

(21) Appl. No.: 11/981,942

(22) Filed: Nov. 1, 2007

(30) Foreign Application Priority Data
Nov. 3, 2006 (IT) RA2006000064

(51) Int. Cl. H01P 1/203

(52) U.S. Cl. 333/204; 333/238

(57) ABSTRACT

A microstrip structure comprising a conductive layer whose width varies in such a way as to obtain an effective dielectric constant, which presents a sinusoidal shape modulation. The propagation of electromagnetic waves in materials with electromagnetic properties, which varies along their propagation direction having desirable characteristics, such as the presence of frequency bands in which the propagation is allowed and of bands in which the electromagnetic waves are stopped.

### FIELD OF THE INVENTION

The present invention relates to the field of electromagnetic wave propagation. More specifically, the present invention relates to the propagation of electromagnetic waves through a microstrip structure with a dielectric constant which varies inside the structure. In particular, the present invention relates to a device which is used as support for the propagation of electromagnetic waves and which comprises a layer of dielectric material and at least one conductive layer or conductive track, in which the relative dielectric constant of the device is modulated by the shape of the conductive layer or conductive track. In more detail, the present invention is related to a device suited for the propagation of electromagnetic waves where the dielectric constant is periodically modulated along a predetermined direction by a periodic variation of the shape of the conductive layer along the same predetermined direction. Additionally, the present invention relates to a device which is suited for the propagation of electromagnetic waves whose effective dielectric constant is sinusoidally modulated along a predetermined direction by a periodic variation of the shape of the conductive layer along the same direction. The periodic and/or sinusoidal variation can be related to or in regard to the width of the conductive layer, its thickness, or both of these characteristics.

### BACKGROUND OF THE INVENTION

In recent years, a large interest has been shown in materials which present an electromagnetic band gap structure (known as EBG materials), which means the materials are selective in frequency and therefore allow the propagation of electromagnetic waves of a given frequency while blocking the propagation of waves with other frequencies. This phenomenon presents strong similarities with the band structure of materials with a crystalline structure. As is known from solid-state physics, there are materials such as semiconductors which have a band energy structure such that an electron can have only energy values which correspond to an allowed energy band, while it cannot have values which correspond to a forbidden band. Similar to semiconductor materials, which allow the conduction of electrons with an energy which is comprised in a conduction band, the EBG materials allow the propagation of electromagnetic waves with frequencies comprised within given bands or intervals while they block the wave propagation of waves with frequencies outside the bands or intervals.

The EBG materials have become widely employed in antenna applications, as for example leaky wave antennas, lens antennas or also surface wave coupling reduction between antennas, etc. (see for example: Fan, Y.; Rahmat-Samii, Y.; “Microstrip antennas integrated with electromagnetic band-gap (EBG) structures: low mutual coupling design for array applications”, IEEE Trans. AP, pgs 2936-2946, October 2003).

The EBG behavior can be obtained in different ways, for example by arranging reactive loads, with concentrated or distributed parameters, which are smaller than the wavelength of the wave that propagates in the device or by modulation of the media's electromagnetic properties.

In particular, modulation of the electromagnetic properties of a structure can be obtained using different techniques, such as for example the modulation of its physical characteristics; that is placing materials with different dielectric constants side-by-side or one on top of another or by using electro-optic materials, materials which change their dielectric properties under the application of electromagnetic fields. Furthermore, the modulation of the parameters of the material can be achieved by drilling holes in the dielectric material. A complete characterization of EBG material can be carried out by a dispersion diagram, which represents the wavenumber as a function of the frequency of the electromagnetic waves (see for example: Brillouin, L. “Wave Propagation in periodic structures”, New York: Dover, 1953).

However, even though these techniques are widely used to obtain a structure with EBG behavior, they still present disadvantages and/or problems.

For example, the drilling techniques, with or without metallization, have proved not to be suited for microstructures, which are required by the demand for ever greater scale reduction of circuits and/or devices. In fact, it has proved very difficult, if not impossible, to realize microholes with dimensions suited for today's circuits, such as integrated circuits or the like.

In the same way, structures with different layers have proved to be costly and not competitive due to the costs.

Finally, the behavior of an EBG material and/or of the structure which can be realized with the known techniques has often proved to be very unstable and/or sensible to the influence of environmental factors.

Therefore, there is a need for improved structures for the transmission of electromagnetic waves in a dielectric for use in many electronic devices.

### SUMMARY OF THE INVENTION

It is, therefore, an object of the present invention to overcome or reduce the disadvantages of the known techniques mentioned above.

In particular, the object of the present invention is to obtain structures or materials suited to the propagation of electromagnetic waves which present a stable EBG behavior and which are not influenced by environmental factors.

It is a further object of the present invention to provide materials and/or structures that can be manufactured at competitive costs and present dimensions suited to the demand for an always greater miniaturization of devices and/or circuits in general.

Furthermore, the proposed structure, as it does not present any holes, is easier to manufacture with lower costs. For the same reason, it also presents a larger mechanical resistance.

According to one embodiment of the present invention, the substrate can be multilayer, meaning that the conductive layer is located in a multilayer structure made of dielectric materials with different relative dielectric constants. According to a further embodiment, the conductive layer is located closer to the interface with the air, but not necessarily at the air-dielectric interface. This solution or embodiment allows the device to have an M value (modulation factor) which permits control over the position and width of the forbidden or filtered bands.

The present invention is based on the consideration that a device and/or structure suited for the propagation of electromagnetic waves and which presents an EBG behavior can be obtained by modulation of at least one of the electromagnetic properties of the structure and/or device. Furthermore, the present invention is based on the consideration that the EBG behavior can be obtained by modulation of the effective dielectric constant of the structure or device. Particularly, the present invention is based on the consideration that an appropriate modulation of the dielectric constant of the structure or device, one that provides an EBG behavior, can be obtained by realizing a conductive layer whose shape and/or dimensions are not constant but vary along a predetermined direction so as to modulate the effective dielectric constant of the structure and/or device along the direction and the predefined profile.

According to the most general embodiment, the present invention relates to a device suited for the propagation of electromagnetic waves and comprising a conductive mass plate, a substrate, and at least one other conductive layer in which at least one electromagnetic property of the device is modulated in a periodic way within the device by said conductive layer.

According to a particular embodiment as, the effective dielectric constant of the device is modulated by the shape of the at least one conductive layer.

According to a further embodiment, the width of the at least one conductive layer varies in a substantially periodic way along a predetermined direction, so that the dielectric constant is periodically modulated along the predetermined direction.

According to another embodiment, the width of the at least one conductive layer varies substantially sinusoidally along the predetermined direction, so that the effective dielectric constant is modulated according to a substantially sinusoidal profile along the predetermined direction.

Further embodiments of the present invention are will become readily apparent in view of the following description.

### BRIEF DESCRIPTION OF THE DRAWINGS

Further advantages, objectives and characteristics of the present invention are defined in the claims and they will become clear from the following detailed description together with the figures in which identical or corresponding parts are identified by the same reference numerals. In particular,

FIG. 1 schematically represents a microstrip structure according to the state of the art in which the conductive layer has a constant width. The one-layer structure has a mass plate on the opposite side of the strip;

FIG. 2 schematically represents a microstrip structure according to a first embodiment of the present invention in which the conductive layer is continuous and the width is not constant;

FIG. 3 schematically represents a microstrip structure according to a further embodiment of the present invention in which the conductive layer is not continuous and the width is not constant;

FIG. 4 schematically represents the dispersion diagram of the microstrip structure according to the present invention, in which it is possible to recognize the band structure;

FIG. 5 schematically represents the dispersion diagram of a normal microstrip structure according to the state of the art with a conductive layer of constant width;

FIG. 6A schematically represents a further embodiment of the present invention, in which a plurality of parallel conductive layers is disposed on a dielectric substrate which is in phase;

FIG. 6B schematically represents a further embodiment of the present invention, in which a plurality of parallel conductive layers is disposed on a dielectric substrate which is out of phase;

FIG. 7 schematically represents a further embodiment of the present invention, in which a plurality of conductive layers are disposed in a longitudinal and transversal way on a substrate, so that a conductive lattice is realized;

FIG. 8 schematically represents a further embodiment of the present invention in which the modulated line does not lie at the interface air-dielectric, but rather is located between two dielectrics.

### DETAILED DESCRIPTION OF THE PREFERRED EMBODIMENTS

Even if the present invention is described with reference to the embodiments which are described in the following and represented in the figures, it should be noted that the present invention is not limited to the particular embodiments described in the following detailed description and represented in the figures, but that the described embodiments are simply examples of different aspects of the present invention, whose scope is defined in the claims.

As previously anticipated, according to the present invention one possible way to confer an EBG behavior to a structure suited for the propagation and/or transmission of electromagnetic waves is to modulate the effective dielectric constant, for example following a periodic profile, in particular a sinusoidal profile.

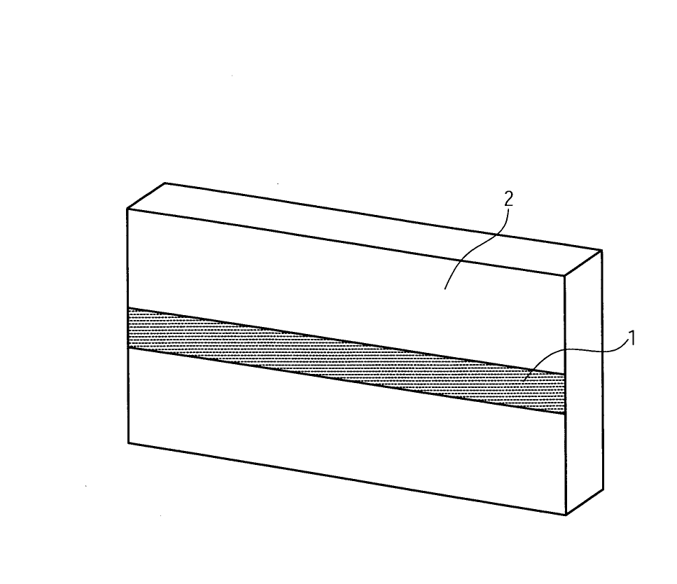

In fact, if one considers a microstrip structure as represented in FIG. 1, which comprises a thin and flat electric conductor 1 separated from a mass plate (not shown in FIG. 1) by a dielectric material 2, the following consideration may be made.

Microstrip structures of this type are widely used as transmission lines for microwaves. The electromagnetic waves which propagate in a microstrip structure of this kind diffused in part of the dielectric material and in part in the air. The propagation velocity of the electromagnetic waves corresponds therefore to a value which is comprised between the wave propagation velocity in the dielectric and the propagation velocity in the air. The microstrip structure is therefore characterized by an effective dielectric constant ε_{eff} which is given by the formula (for details Hammerstad, E. and Jensen, O., “Accurate Models for Microstrip Computer-Aided Design”, Digest of 1980 IEEE MTT-S International Symposium, Washington D.C.):

$${ɛ}_{eff} = \frac{{ɛ}_{r} + 1}{2} + \frac{{ɛ}_{r} - 1}{2} {( 1 + 10 \frac{h}{w} )}^{- 0.5} \qquad ( 1 )$$

in which εᵣ is the dielectric constant of the dielectric material, h is the thickness of the dielectric material and w is the width of the conductive layer. This formula is valid for the fundamental mode of the microstrip structure. Corrections to this expression are known in the literature.

By inverting the previous expression it is possible to find the value of the width of the conductive layer as a function of the dielectric constant εᵣ, the effective dielectric constant ε_{eff} and the thickness h as shown in the formula:

$$w = 2.5 h \frac{{( 2 {ɛ}_{eff} - {ɛ}_{r} - 1 )}^{2}}{( {ɛ}_{r} - {ɛ}_{eff} ) ( {ɛ}_{eff} - 1 )} \qquad ( 2 )$$

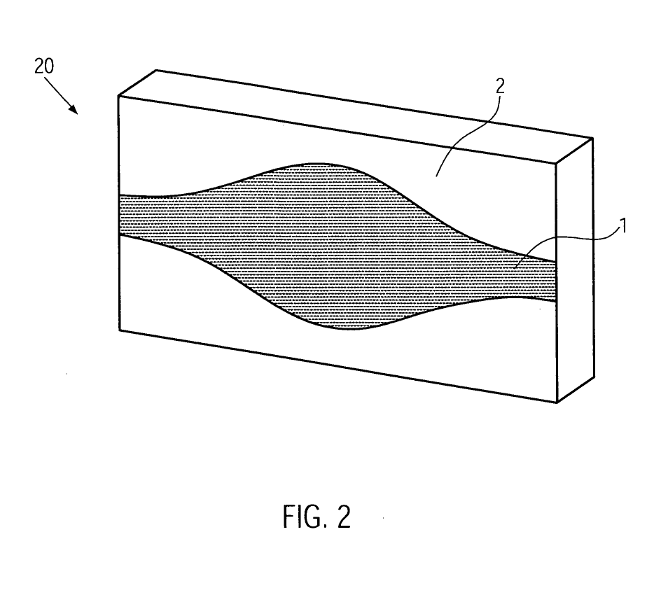

The inventors faced therefore the problem of determining the behavior of a microstrip structure of the type represented in FIG. 2, in which the conductive layer 2 does not have a constant width along the propagation direction of the electromagnetic waves, and they arrived at the conclusion that, as previously shown, the effective dielectric constant of a microstrip structure depends on the width of the conductive layer. By varying this width it is possible to modulate the value of the effective dielectric constant along the propagation direction. The inventors arrived therefore at the unexpected conclusion that in this way it is possible to obtain a microstrip structure with new electromagnetic properties, which can bring considerable advantages in many applications. In particular, the modulation of the effective dielectric constant can allow the structure to block certain wavelengths and let others propagate through, acting therefore as a filter.

A particular case has also been considered, where an effective dielectric constant varies in a sinusoidal way along the propagation direction, as expressed by the formula:

$${ɛ}_{eff} ( u ) = {ɛ}_{avg} ( 1 - M cos \frac{2 π u}{D} ) \qquad ( 3 )$$

in which u is the position along the propagation direction of the electromagnetic wave, D is the period and M is the modulation constant that satisfies the condition that |M|<1. This represents the simplest modulation scheme and as will be shown later, it confers to the structure an EBG behavior.

By substituting the value of the desired effective dielectric constant, as expressed in the equation (3), in the equation (2) of the width of the conductive layer, it is possible to determine the width along the propagation direction of the electromagnetic waves.

In a particular embodiment of the present invention, M is a real value, which corresponds to the case without absorption of the electromagnetic wave by the structure. When M assumes complex values, the effective dielectric constant becomes complex, which corresponds for example to the heat dissipation by the Joule effect in the dielectric material. In a further particular embodiment of the present invention, the effective dielectric constant varies only in the propagation direction of the electromagnetic waves.

To study the behavior of this structure with a modulated effective dielectric constant according to equation (3), it is necessary to insert the equation (3) in the Maxwell equation. In this way a system of equations with partial derivatives results with the necessary boundary conditions. From this system, it is possible to obtain two distinct expressions, one for the transverse electric field and one for the transverse magnetic field with respect to the modulation direction (for details: Tamir, T. et al., “Wave propagation in Sinusoidally Stratified Dielectric Media”, IEEE Trans. on MTT pp. 323-335, May 1964).

Because of the diverse nature of the equations that one obtains, the transverse electric field (TE) and the transverse magnetic field (TM) can be treated separately. The transverse magnetic field can be obtained analytically by means of the Hill functions, while the transverse electric field can be obtained in terms of the Mathieu functions, which are a particular case of the Hill functions.

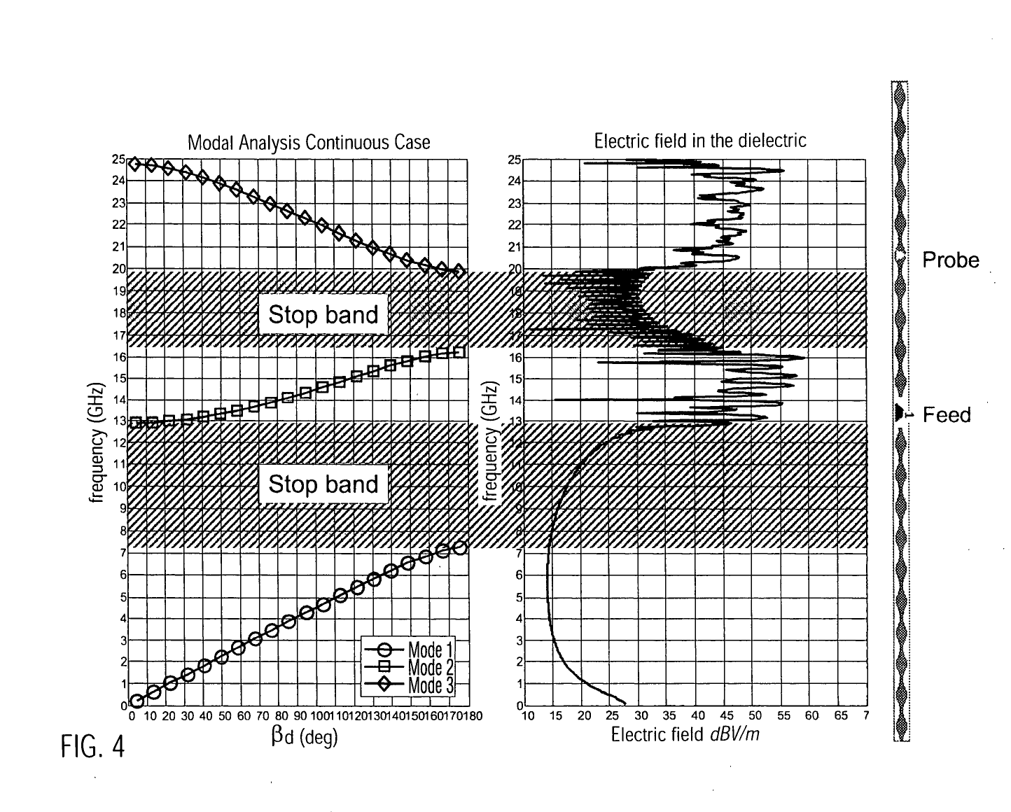

From the solution of the Maxwell equation for the microstrip structure of the present invention having a conductive layer with a variable width which follows an almost sinusoidal profile, as in equation (3), it is possible to obtain the band structure as shown in FIG. 4.

The limits of the bands, which allow the propagation of the electromagnetic waves or stop the electromagnetic waves, can be obtained by the intersection between the line which corresponds to the modulation parameters and the limits of the stability zones of these functions. The behavior inside the band is described by the relative functions of non-integer order.

In a particular embodiment of the present invention, a microstrip structure with a unique conductive layer in which the effective dielectric constant varies is considered.

FIG. 2 schematically illustrates a period of a particular embodiment of the present invention in which the structure 20 comprises a dielectric substrate 21 on whose surface is disposed a conductive layer 22. The conductive layer 22 extends longitudinally along the entire length of the substrate 21 as shown in FIG. 2. The electromagnetic waves propagate inside the structure represented in FIG. 2 along the direction in which the conductive layer extends longitudinally. In the following, this propagation direction will be defined as the predetermined or predefined direction. The shape of the conductive layer and in particular its width, measured in the direction perpendicular to the propagation direction, varies periodically according to a function which results from equation (3).

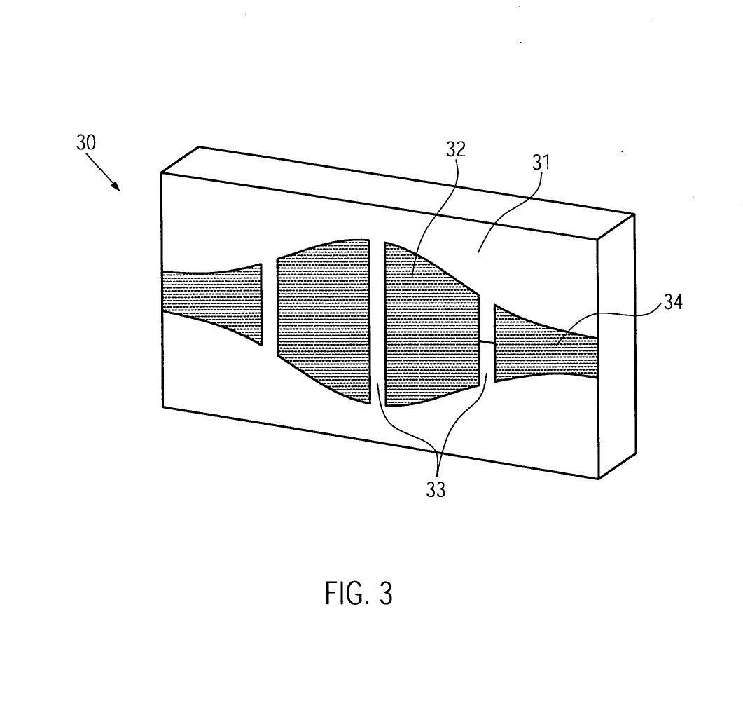

In FIG. 3 a particular embodiment of the present invention is schematically shown in which the structure 30 comprises a dielectric substrate 31 on whose surface is disposed a non-continuous conductive layer 32. The conductive layer 32 extends longitudinally along the entire length of the substrate 31 and it is interrupted by non-conductive strips/zones 33 as shown in FIG. 3. The conductive layer 32 is therefore made up of conductive and non-conductive strips. The length in the predefined longitudinal direction of both the conductive and non-conductive strips is constant along all the substrate. On the contrary, the width, measured in the transverse direction, of the conductive strips is variable and it describes a periodic profile as shown in FIG. 3.

The dimension in the longitudinal direction of the non-conductive strips 33 in a further particular embodiment of the present invention has a value of 0.2 mm.

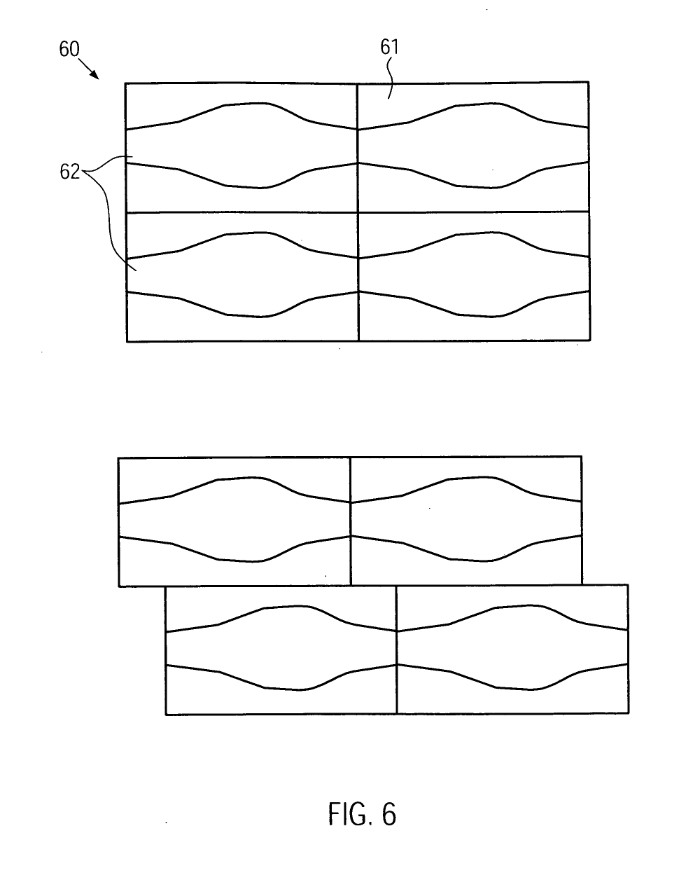

FIG. 6A schematically illustrates a further particular embodiment of the present invention in which the bi-dimensional structure 60a comprises a dielectric substrate 61 on whose surface are disposed a plurality of conductive layers 62. The conductive layers are parallel and there is no contact between the different conductive layers 62 as shown in FIG. 6A. The conductive layers 62 extends longitudinally along the entire length of the substrate 61 as shown in FIG. 6A. The different conductive layers 62 have a periodic profile which is substantially sinusoidal and are in phase with one another as shown in the upper FIG. 6A. In particular, with the expression “in phase”, it should be understood that the functions of the width of the two conductive adjacent layers which are periodical along the predefined longitudinal direction are in phase between them, at a given value u corresponds the same value of w.

On the contrary, according to a further embodiment of the present invention the conductive layers can be out of phase, as shown in the lower FIG. 6B illustrating another bi-dimensional structure 60b. In this case the functions that express the periodicity along the predefined longitudinal direction of the width of the two adjacent conductive layers 62 are out of phase, at a given value of u correspond different values of w.

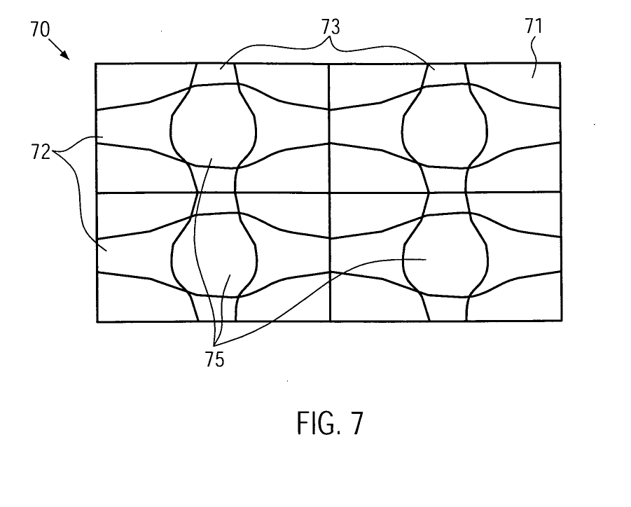

FIG. 7 schematically shows a particular embodiment of the present invention in which the two dimensional structure 70 comprises a dielectric substrate 71 on whose surface are disposed conductive longitudinal layers 72 and conductive transverse layers 73. The longitudinal conductive layers 72 are parallel and there is no contact between them, as shown in FIG. 7. The same is valid for the transverse conductive layers 73. The longitudinal conductive layers 72 come into contact with their respective transverse layers 73 in the contact points 74. Both the longitudinal 72 and transverse 73 conductive layers extend respectively longitudinally and transversally for the entire length/width of the dielectric substrate 71. The conductive layers 72 and 73 therefore form a radical structure on the dielectric surface 71. In this particular embodiment the electromagnetic waves can propagate in both the longitudinal and transverse directions.

In a particular embodiment of the present invention the dielectric material 2 is made of Arlon 350 with a thickness of 1.58 mm and the conductive layer 1 is made of copper with a thickness of 35 μm as is the mass layer behind.

In a particular embodiment of the present invention the modulation of the effective dielectric constant takes place in a continuous way in one dimension (1D) thanks to a continuous conductive layer, as shown in FIG. 2, whose width varies periodically and/or substantially sinusoidally.

In a particular embodiment of the present invention the conductive layer is not continuous and it is interrupted by non-conductive zones, that is it is made of conductive strips alternated with non-conductive zones. The width of the conductive strips is not constant.

In a particular embodiment of the present invention the width of the strips varies in a periodic way and/or sinusoidal way according to the profile of equation (3) as shown in FIG. 3. The distance between the different conductive strips is smaller than the wavelength of the electromagnetic waves which propagates in the microstrip structure. This particular embodiment of the present invention has the advantage that it prevents the passage of continuous current along the conductive layer and therefore it is useful when active elements (for example for the control of the phase difference) are inserted into the system.

In a particular embodiment of the present invention the value of ε_{avg} is 2.67 and that of M=Δε=0.11.

In a further embodiment of the present invention the frequency of the electromagnetic waves employed is within the range of 0 to 25 GHz.

In a particular embodiment of the present invention the width of the conductive layer varies between a minimum of 0.70 mm and a maximum of 3.50 mm on a period of 10 mm.

In a particular embodiment of the present invention the conductive layer is not continuous and it is interrupted by cuts which have a width of 0.2 mm.

In a further embodiment of the present invention a plurality of conductive layers are disposed on the dielectric substrate as shown in FIG. 6. The different conductive layers are disposed on the same plane and are parallel to each other.

In a particular embodiment, the particular shapes of the conductive layers can be in phase as shown in FIG. 6A or they can be disposed out of phase as shown in FIG. 6B. In a further embodiment of the present invention the conductive layers which are disposed on the dielectric substrate can come into contact forming therefore a two-dimensional conductive lattice as shown in FIG. 7. These two-dimensional embodiments according to the present invention can be employed as a substrate to reduce cross-talk between data transmission lines. Actually, this is the most widely employed application. Furthermore, reducing the coupling means that the lines can be placed closer to each other and therefore the dimensions of the entire circuit can be reduced with an important advantage in terms of costs, volume, etc.

In a further embodiment of the present invention the modulation of the effective dielectric constant can be obtained by varying the thickness of the conductive layer instead of the width as mentioned in the previous embodiments. The thickness of the conductive layer is therefore not constant.

In a particular embodiment of the present invention the modulation of the dielectric constant can also be due to variation in the composition of the conductive layer or by employing different conductive materials.

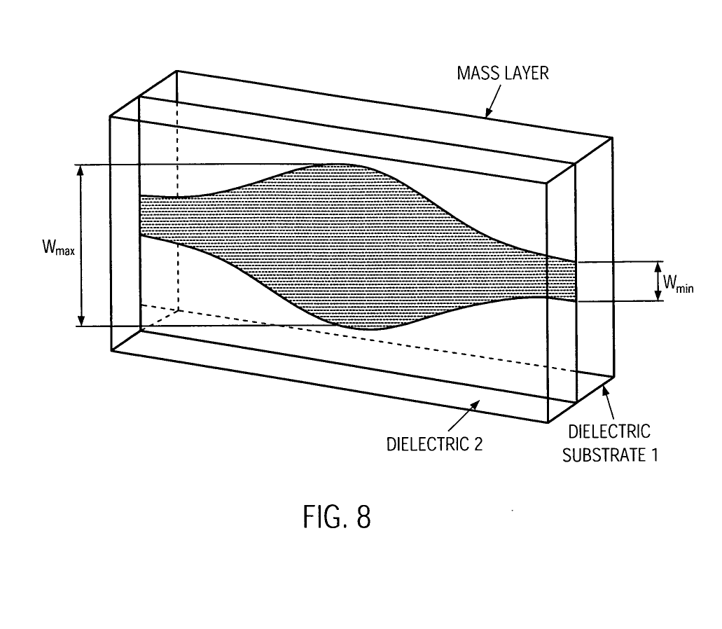

FIG. 8 represents a further embodiment according to the present invention in which the conductive layer is inside the dielectric material. Alternatively, the conductive layer can be disposed between two layers of different dielectric materials, dielectric substrate 1 and dielectric 2, like in a sandwich. Also the plurality of conductive layers represented in the FIG. 6A and 6B and 7 can be inside a dielectric substrate or they can be disposed between two or more layers of different dielectric materials.

A particular embodiment of the present invention comprises a device which is used as support for the propagation of electromagnetic waves which comprises one layer of dielectric material with two conductive layers, one on each side, wherein one is continuous and uniform, mass layer, and the other is made of parallel strips with a width which varies periodically so that the relative effective dielectric constant of the device is periodically modulated by the shape of the conductive layer.

### Numerical Analysis of the Properties of the System

The microstrip structure with a conductive layer with a continuous sinusoidal shape as shown in FIG. 2 and the structure with a non-continuous shape as shown in FIG. 3 were analyzed in detail to better show the characteristics. In particular these two cases were examined by an eigenvector analysis and by a numerical analysis with transient solver in the time domain. The results were then represented in a dispersion diagram and they were compared also with the dispersion diagram of the structure with a constant width conductive layer as shown in FIG. 1 in order to underline the differences in behavior.

For the numerical calculation by means of the transient solver analysis a structure was considered where the structure consisted of twenty-one unitary cells in which each cell corresponds to a modulation period for the continuous case as well as for the discrete case.

For the numerical calculation, a sinusoidal profile was taken with a width varying between a minimum of 0.70 mm and a maximum of 3.50 mm over a period of 10 mm. In the described case the interruptions have a width of 0.20 mm.

The band structure can be easily recognized in FIG. 4 which shows frequency bands in which the electromagnetic radiation is propagating and bands where it is stopped.

The graph is the result of numerical calculation for a structure with a conductive layer with a continuous and not-continuous sinusoidal shape. The numerical calculations show that the behavior of these two variants is very similar with the exclusion of the fundamental mode of the continuous structure that is the transverse electromagnetic mode (TEM).

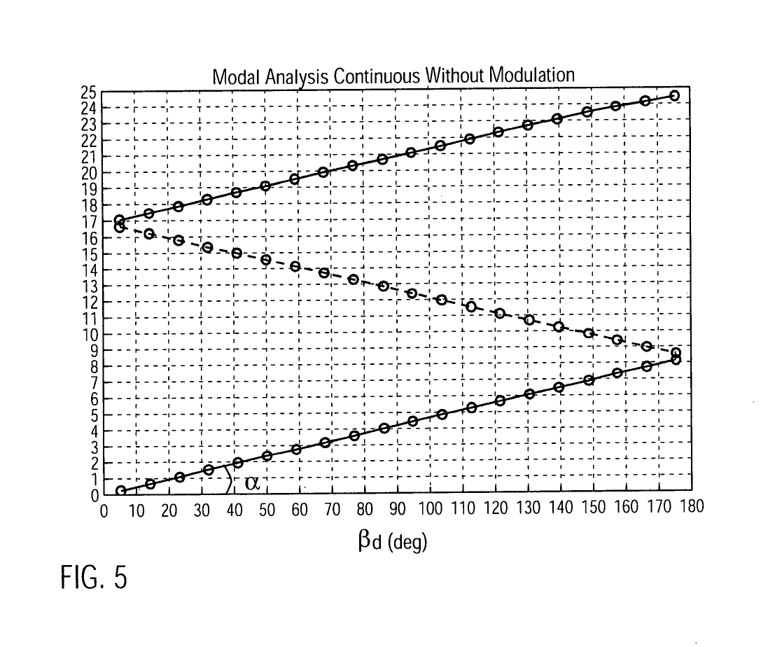

The behavior of these two variants presents clear differences if compared with the case of a microstrip structure with a conductive layer of a constant width. The respective dispersion graph is shown in FIG. 5. As one can see in FIG. 5 there are no forbidden frequency bands.

In the particular case shown in FIG. 4 in which the frequency of the electromagnetic waves varies between 0 and 25 GHz, the limits of the band which allows the propagation and the bands which stop the propagation are: 0-7, 24-12, 905-16, 23-19, 89-24, 76 GHz.

It has therefore been shown that the present invention allows one to obtain the desired results. The EBG structure according to the present invention can be realized with a low cost, for example by realizing on a dielectric substrate one or more conductive layers or tracks using a lithography process, or etching or the like.

Furthermore, as already mentioned previously, the device of the present invention can function as a filter in order to eliminate frequency bands thanks to the EBG behavior of the material. The device of the present invention is moreover adapted in order to be applied in integrated circuits. Furthermore, the surface of the device represents a high impedency surface and it is therefore an artificial magnetic conductor.

The EBG properties of the device can be used in order to reduce the coupling between radiators in the applications in which a plurality of antennas are present. Furthermore, the device can be applied in leaky antennas or for the reduction of the diffraction from the boards of a limited mass plane or more in general in all applications in which it is necessary to eliminate the surface waves.

The device of the present invention can moreover be employed in order to suppress modes in the case that it is located between two parallel metallic plates, parallel plate mode suppression.

Considering the filter behavior, the device of the present invention can be employed for noise isolations inside devices, for example it can be employed as a substrate for buses in order to reduce the ratio between the signal and the noise and to eliminate cross-talk phenomena. This has the advantage that, reducing the coupling between the lines of a bus, it is possible to dispose the lines closer to each other, so that the occupied space can be reduced, which is very important for packaging applications.

Furthermore, the periodicity of the width of the one or more conductive layers can be realized on the basis of the requested periodicity for the effective dielectric constant and/or to obtain a particular desired EBG behavior. This EBG behavior will be stable and not influenced by external factors.

Although the preferred embodiments are illustrated and described, it will be obvious to those skilled in the art that various modifications may be made without departing from the spirit and scope of this invention.

What is claimed is:

1. A device suited for the propagation of electromagnetic waves comprising:
a substrate; and
at least one conductive layer,
wherein at least one electromagnetic property of the device is modulated in a periodic way inside the device by said at least one conductive layer.

2. The device according to claim 1 wherein:
one of the electromagnetic properties is an effective dielectric constant.

3. The device according to claim 2 wherein:
the effective dielectric constant is modulated by a shape of said at least one conductive layer.

4. The device according to claim 3 wherein:
the effective dielectric constant is modulated by a width of said at least one conductive layer.

5. The device according to claim 4 wherein:
the width of said at least one conductive layer varies substantially periodically along a predetermined direction, so that the effective dielectric constant is periodically modulated along the predetermined direction.

6. The device according to claim 5 wherein:
the width of said at least one conductive layer varies substantially sinusoidally along the predetermined direction, so that the effective dielectric constant is modulated following a substantially sinusoidal profile along the predetermined direction.

7. The device according to claim 4 wherein:
the effective dielectric constant is modulated by the thickness of said substrate.

8. The device according to claim 7 wherein:
the thickness of said substrate varies periodically along the predetermined direction.

9. The device according to claim 8 wherein:
the thickness of said substrate varies substantially sinusoidally along the predetermined direction.

10. The device according to claim 1 wherein:
said at least one conductive layer is continuous.

11. The device according to claim 1 wherein:
said at least one conductive layer is not continuous.

12. The device according to claim 11 wherein:
said at least one conductive layer is interrupted by non-conductive strips.

13. The device according to claim 1 wherein:
the device is a microstrip structure.

14. The device according to claim 1 wherein:
the device comprises a plurality of conductive layers.

15. The device according to claim 14 wherein:
the plurality of conductive layers are disposed substantially parallel.

16. The device according to claim 15 wherein:
the width of the plurality of conductive layers varies periodically along the predetermined direction and in that the periodicity of two adjacent layers of the plurality of conductive layers is substantially in phase.

17. The device according to claim 16 wherein:
the width of the plurality of conductive layers varies periodically along the predetermined direction and in that the periodicity of two adjacent layers of the plurality of conductive layers is substantially out of phase.

18. The device according to claim 1 wherein:
the device allows the propagation of electromagnetic waves with a predetermined frequency and it stops the propagation of electromagnetic waves with frequencies which are different from the predetermined frequencies.

19. The device according to claim 1 wherein:
the device is suited to be part of an integrated circuit.

20. The device according to claim 1 wherein:
the device is suited for the propagation of microwaves.

21. The device according to claim 1 wherein:
the device is suited for the propagation of electromagnetic waves with a frequency comprised between 0 and 25 GHz.

22. The device according claim 1 wherein:
the width of said at least one conductive layer is comprised between 0.70 mm and 3.50 mm.

23. The device according to claim 1 wherein:
said substrate is made of dielectric material.

24. A device according to claim 1 wherein:
the device comprises a circuit suited for the propagation of electromagnetic waves.

25. The device according to claim 24 wherein:
the circuit is an integrated circuit.
